(19) United States
(12) Patent Application Publication
(10) Pub. No.: US 2009/0137443 A1
(43) Pub. Date: May 28, 2009

(54) Fabric Prespotter with Delivery System

(75) Inventor: Darlene Ann Myers, Kingsville, MD (US)

Correspondence Address: DARLENE ANN MYERS, 8 JERUSALEM MILL COURT, KINGSVILLE, MD, 21087-1538, US

(73) Assignee: Darlene Ann Myers, Kingsville, MD (US)

(21) Appl. No.: 11/693,563

(22) Filed: Jun. 4, 2007

(51) Int. Cl. C11D 3/00

(52) U.S. Cl. 510/283

(57) ABSTRACT

Universal cleaning composition that cleans grease, tar, oil, grass stains, dirt, chocolate, spaghetti sauce, juice, greasy food and is compatible with many different washable fabric types. When soiled portions of washable clothing fabric are treated directly with cleaning composition, with an applicator that sprays, rubs, dabs, or squeezes liquid where necessary, stain or soil is removed after machine washing in hot water, without any damage to clothing fabric. Even stains that are washed, dried and set in fabric can be removed with this cleaning composition and application method.

### BACKGROUND OF INVENTION

This invention relates to a cleaning composition and method for treating stains in clothing fabric.

My invention is more directed to removing stains from clothing fabric that normally require numerous methods and applications before said stain can be removed. When hard to remove stains are treated with cleaning composition by a delivery method of spraying, squeezed or dabbed, directly on stained area of clothing, let set 30 seconds to 1 minute, then laundered normally in washing machine, the stain is removed like magic. So many articles of clothing, especially children's clothing, are stain ruined. There are numerous soil and spot treatment on the market, which are virtually worthless compared to this composition which is easy to use, and removes most stains in most fabrics without any damage to fabric. Using a spray method, with a spray applicator, a squeezing method, squeezing of composition through narrow end or dabbed method, saturate cloth end to dab onto stain, to apply composition, controls administering composition only to stained area of fabric. Application method also controls volume and levels of saturation administered to stained area prior to normal machine washing. Women everywhere would love a composition that actually removes stains from clothing without much effort and that is easy to apply, then restores fabric to pre-stain condition. So many everyday stains just are not removed through normal laundering and most prespotters on market today are virtually worthless.

### SUMMARY OF INVENTION

This invention is in the field of stain and soil removal from washable clothing fabric with a method for applying composition, prior to normal machine laundering. It relates to treating washable clothing fabric stains and or soil by applying cleaning composition directly to stain with an applicator, that controls volume applied and the area treated with composition. When applying composition to stains in a garment, an applicator such as a
(a) pen container, that is squeezed through narrow top,
(b) cloth tab ©container, such as shoe polish container,
(c) stick applicator, which is rubbed on, such as a glue stick,
(d) spray bottle
   is used, cleaning composition is administered only to area to be treated prior to normal laundering. By using one of the above delivery methods, only the soiled area is treated, and saturation level is than controlled as to personal use, which depending on the stain, different levels of saturation will sometimes become necessary. Delivery method also eliminates the pouring of composition from the bottle, onto stain which then saturates areas not meant to be treated, because there is no control as to where liquid flows once poured, which is a waste of product and at present is the only way to apply this composition to stains. These delivery methods give total control for the area you want to treat and level of saturation necessary. People will be amazed at the ease of use by this delivery method and the wonderful results, this composition achieves, for stain removal. When one of the suggested delivery method's is used, and composition is applied directly to stain prior to normal laundering, saturating stain first, nothing removes more stains in more fabrics than said composition and method, and I've tried everything over the years. After hearing so many complaints about stain removal, I have decided my idea needs exposure, and women everywhere need all the help available to them.

### DETAILED DESCRIPTION OF THE INVENTION

The present invention is based on my discovery years ago when trying to remove grass stains from jeans with no success until I used a cleaning composition normally used for grease removal and heavy duty cleaning. I poured the composition directly onto the grass stains, then laundered normally in the washing machine and was amazed with the results. The grass stains were totally removed from the jeans. Eventually I tried applying the composition on different washable fabrics and different stains with almost complete stain removal success and no damage to the washable clothing fabric. This liquid composition used is a universal cleaner readily available commercially and sold under the ™ Lestoil, and is now manufactured by the Clorox Corporation. The composition is a petroleum distillate (a mixture of hydrocarbons having a boiling point between 150.degress.-190.degree.C.) emulsified in water with 10-15% pine sol added and 10-15% sodium salt. Lestoil is sold as a heavy duty cleaner and mentions that you can add to laundry to remove grease. It is sold in a bottle that is great for pouring into other liquid or another container to aid in cleaning greasy areas or spots as a heavy duty cleaner. But pouring this composition from its bottle in order to treat soil and stains in washable clothing fabric is not feasible economically, besides being messy. In order to treat a specific stain or area of fabric economically, you need to control the direction, the amount and the level of saturation, when dispensing composition. Otherwise, liquid composition flows freely over areas not needed to be treated, and the amount of composition poured for saturation purposes is usually way more than necessary, which then becomes a messy and wasteful process. A necessary part of this invention is the applicator used to apply composition, which directs flow and level of saturation for more precise treatment of stains and soil in washable clothing fabric. Without applicator the process becomes hit or miss on treating stained area and the intended results may not occur. Using an applicator that dabs, rubs, squeezes, or sprays liquid composition in a process that treats stains in washable clothing fabric prior to normal laundering for complete stain removal is a new use for an old product that has been around since Oct. 3, 1936, serial #71383910.

After discovering this liquid compositions effect on grass stains in jeans, I began experimenting on every stain imaginable and every washable fabric. Most stains are not removed during normal machine laundering, contrary to what is advertised on laundry products. Most fabric stains need some kind of pretreatment for stain removal, and many stains need to be treated numerous times, sometimes with no positive results. There are some hard to remove stains that can not be removed with pretreatment products on the market no matter how many times you treat them. What I found using this liquid composition, was that almost all the stains or soil were removed totally after only being treated once, before laundering in hot water. When a hard to remove stain was not removed the first time, I treated the stain a second time with liquid composition, then rewashed garment and had total stain removal. All the washable fabric I treated with liquid composition, even stains treated twice, came out looking like new or pre-stain condition without any damage to fabric from composition. It's amazing to see stains and soil totally removed from garment and fabric returned to like new condition with this easy treatment.

The first challenge I had after discovering this products remarkable stain removing capabilities, was how to effectively treat stains or soil efficiently. Because, pouring liquid composition from the bottle became a very wasteful and messy task, as liquid flows uncontrolled until it hits a barrier or is saturated into fabric. When you wanted to pinpoint a stain on a garment or treat a soiled area you usually poured more than needed, besides saturating unstained parts of fabric, so a more economical solution was necessary.

The application process became a trial and error, as this composition was successful at removing most stains from all washable fabrics I tried, but applying composition wasn't always so easy, until I found several applicators that served the purpose of applying composition, just to area that needed to be treated with the amount of saturation to remove stains. The application process requires an applicator and method to apply composition as follows:
(a) dabbed cloth bottle, such as a shoe polish applicator,
(b) pen container, by which composition can be squeezed through narrow head,
(c) stick applicator, whereby composition is rubbed onto stain, much like a glue stick
(d) spray bottle, where composition is sprayed directly on stain

By using one of the applicators to apply composition to stained or soiled area to be treated, you then have control over the application process, which is not available when pouring composition from bottle as sold.

Applying composition with one of the applicators allows pinpoint precision to where liquid composition contacts the stained or soiled areas, plus allows control of the amount of composition applied. When composition is applied to fabric stains directly by spraying, dabbing, rubbing or squeezing, you can limit the amount of composition applied to the type of stain for saturation purposes, as some hard to remove stains need more saturation than others. Once one of the applicators is used to apply the composition, the treatment process is comprised of:
(a) dispensing composition by, spraying, dabbing, rubbing or squeezing onto stain or soil in washable clothing fabric
(b) let composition saturate into stain for 30 seconds to a minute or two
(c) launder normally with hot water in washing machine, fabric comes out stain free

The results are amazing. This composition can be applied to all washable clothing fabric without damage to garment and will remove grass, mud, grease, spaghetti sauce, wine, gravy, chocolate, ring around the collar and cuffs and berry stains. This liquid composition will also remove set stains, (stains in fabric that have previously been washed and dried in garment) though sometimes garment must be treated twice and rewashed. It's easy and most effective solution for stain removal, especially, hard to remove stains.

Use this liquid composition and method of applying composition by spraying, rubbing, squeezing, or dabbing on stains and soil in all washable clothing fabric, let composition saturated stain for 30 seconds to a minute or two, then throw into washing machine and launder normally in hot water, when laundry is done, stain is gone. I was so amazed at the results accomplished using this universal cleaning composition as a stain and soil treatment in washable clothing fabric, that I decided every person who does laundry would love this remedy. It's easy, efficient, and it really works.

The present invention is based on my discovery years ago when trying to remove grass stains from jeans with no success until I used a cleaning composition normally used for grease removal and heavy duty cleaning. I poured the composition directly onto the grass stains, then laundered normally in the washing machine and was amazed with the results. The grass stains were totally removed from the jeans. Eventually I tried applying the composition on different washable fabrics and different stains with almost complete stain removal success and no damage to the washable clothing fabric. This liquid composition used is a universal cleaner readily available commercially and sold under the ™ Lestoil, and is now manufactured by the Clorox Corporation. The composition is a petroleum distillate (a mixture of hydrocarbons having a boiling point between 150.degress.-190.degree.C.) emulsified in water with 10-15% pine sol added and 10-15% sodium salt. Lestoil is sold as a heavy duty cleaner and mentions that you can add to laundry to remove grease. It is sold in a bottle that is great for pouring into other liquid or another container to aid in cleaning greasy areas or spots as a heavy duty cleaner. But pouring this composition from its bottle in order to treat soil and stains in washable clothing fabric is not feasible economically, besides being messy. In order to treat a specific stain or area of fabric economically, you need to control the direction, the amount and the level of saturation, when dispensing composition. Otherwise, liquid composition flows freely over areas not needed to be treated, and the amount of composition poured for saturation purposes is usually way more than necessary, which then becomes a messy and wasteful process. A necessary part of this invention is the applicator used to apply composition, which directs flow and level of saturation for more precise treatment of stains and soil in washable clothing fabric. Without applicator the process becomes hit or miss on treating stained area and the intended results may not occur. Using an applicator that dabs, rubs, squeezes, or sprays liquid composition in a process that treats stains in washable clothing fabric prior to normal laundering for complete stain removal is a new use for an old product that has been around since Oct. 3, 1936, serial #71383910.

After discovering this liquid compositions effect on grass stains in jeans, I began experimenting on every stain imaginable and every washable fabric. Most stains are not removed during normal machine laundering, contrary to what is advertised on laundry products. Most fabric stains need some kind of pretreatment for stain removal, and many stains need to be treated numerous times, sometimes with no positive results. There are some hard to remove stains that can not be removed with pretreatment products on the market no matter how many times you treat them. What I found using this liquid composition, was that almost all the stains or soil were removed totally after only being treated once, before laundering in hot water. When a hard to remove stain was not removed the first time, I treated the stain a second time with liquid composition, then rewashed garment and had total stain removal. All the washable fabric I treated with liquid composition, even stains treated twice, came out looking like new or pre-stain condition without any damage to fabric from composition. It's amazing to see stains and soil totally removed from garment and fabric returned to like new condition with this easy treatment.

The first challenge I had after discovering this products remarkable stain removing capabilities, was how to effectively treat stains or soil efficiently. Because, pouring liquid composition from the bottle became a very wasteful and messy task, as liquid flows uncontrolled until it hits a barrier or is saturated into fabric. When you wanted to pinpoint a stain on a garment or treat a soiled area you usually poured more than needed, besides saturating unstained parts of fabric, so a more economical solution was necessary.

The application process became a trial and error, as this composition was successful at removing most stains from all washable fabrics I tried, but applying composition wasn't always so easy, until I found several applicators that served the purpose of applying composition, just to area that needed to be treated with the amount of saturation to remove stains. The application process requires an applicator and method to apply composition as follows:
1. dabbed cloth bottle, such as a shoe polish applicator, composition can be accurately dabbed on stain
2. pen container, by which composition can be squeezed through narrow head, to pinpoint small stains
3. stick applicator, like a glue stick, whereby composition can be rubbed into stain
4. spray bottle, where composition is sprayed directly on stain or larger area that needs treatment

By using one of the applicators to apply composition to stained or soiled area to be treated, you then have control over the application process, which is not available when pouring composition from bottle as sold.

Applying composition with one of the applicators allows pinpoint precision to where liquid composition contacts the stained or soiled areas, plus allows control of the amount of composition applied. When composition is applied to fabric stains directly by spraying, dabbing, rubbing or squeezing, you can limit the amount of composition applied to the type of stain for saturation purposes, as some hard to remove stains need more saturation than others. Once one of the applicators is used to apply the composition, the treatment process is comprised of:
1. Dispensing composition by, spraying, dabbing, rubbing or squeezing onto stain or soil in washable clothing fabric
2. Let composition saturate into stain for 30 seconds to a minute or two
3. Toss treated clothing fabric into washing machine, launder normally in hot water, garment comes out of washer stain free

The results are amazing. This composition can be applied to all washable clothing fabric without damage to garment and will remove grass, mud, grease, spaghetti sauce, wine, gravy, chocolate, ring around the collar and cuffs and berry stains. This liquid composition will also remove set stains, (stains in fabric that have previously been washed and dried in garment) though sometimes garment must be treated twice and rewashed. It's easy and most effective solution for stain removal, especially, hard to remove stains.

Use this liquid composition and method of applying composition by spraying, rubbing, squeezing, or dabbing on stains and soil in all washable clothing fabric, let composition saturated stain for 30 seconds to a minute or two, then throw into washing machine and launder normally in hot water, when laundry is done, stain is gone. I was so amazed at the results accomplished using this universal cleaning composition as a stain and soil treatment in washable clothing fabric, that I decided every person who does laundry would love this remedy. It's easy, efficient, and it really works.

What is claimed:

1. A liquid cleaning composition and method of application for complete removal of soil or stains in washable clothing fabric, when treated prior to normal machine laundering, comprising of the steps of:
(a) applying cleaning composition directly to fabric stain with
(b) applicator that sprays, dabs, rubs or squeezes said cleaning composition directly onto stain.

2. Cleaning composition applied directly to soil or stained area of washable clothing fabric with application method, prior to normal machine laundering, let composition saturate stain or soiled area 30 seconds to a minute, before laundering normally in washing machine with hot water for complete removal of said soil or stain, restoring fabric to original condition.

3. Cleaning composition and application method can be applied to set stains (stains that have already been washed and dried in fabric but not removed) using the same process, for total stain removal.
